(19) United States
(12) Patent Application Publication
(10) Pub. No.: US 2023/0235762 A1
(43) Pub. Date: Jul. 27, 2023

(54) ADJUSTABLE FASTENER

(71) Applicant: Ryan Snodgrass, Lynd, MN (US)

(72) Inventor: Ryan Snodgrass, Lynd, MN (US)

(21) Appl. No.: 18/097,816

(22) Filed: Jan. 17, 2023

Related U.S. Application Data
(63) Continuation-in-part of application No. 17/583,424, filed on Jan. 25, 2022.

(51) Int. Cl. F16B 2/18; F16B 2/24

(52) U.S. Cl. CPC F16B 2/185; F16B 2/243; F16B 2200/20

(57) ABSTRACT

An adjustable locking fastener comprising a post and a lever. The adjustable locking fastener includes a post, a lever and a letoff portion. The adjustable locking fastener may be quickly removed and reattached with minimal effort, and with a constant set point for the attachment.

### BACKGROUND OF THE INVENTION

### Field of the Invention

The invention relates to a quick release adjustable locking fastener.

### BACKGROUND ART

The present invention relates to an adjustable locking fastener with a quick release mechanism. There are many industries where equipment must be connected or closed off, but also need to be maintained, accessed or cleaned. Thus, there is a need for fasteners that provide quick access to the interior of the equipment for cleaning, parts replacement, operational adjustment, and the like, while also providing a reliable seal or closure.

### BRIEF SUMMARY OF THE INVENTION

The present invention solves these needs by providing a quick release adjustable locking fastener that includes a specially designed bolt and a lever that operates with the bolt to provide a secure fastener.

In one embodiment, the adjustable locking fastener includes a post with a shaft and a head and a lever, that includes a first and a second protrusion with a gap between them, the gap sized to accommodate the post; a first raised portion, a second raised portion, and a depression between the first and second raised portion, the depression sized to accommodate the head; and a letoff portion. The lever may be removed from the post without tools. The lever has an open position and a closed position, and the lever is configured to apply a tensioning force to the post in the closed position.

In one embodiment the leftoff portion is rounded. In another the letoff portion is flat. In another the letoff portion has a different axis than the lever.

In another embodiment the head includes a tightening means. The head may include a recess.

In one embodiment the depression is sized to hold the head. The depression may be shaped to provide a letoff when the head is fully seated inside the depression. The depression may surround the head, or it may partially surround the head.

In one embodiment the lever is configured to rotate from the open position to the closed position. The lever may be configured to increase the tension on the post as it rotates from the open position to the closed position.

In another embodiment the letoff portion is configured to reduce the tension on the post at the end of a lever rotation. The lever may be configured to apply a preset amount of tensioning force to the post.

### BRIEF DESCRIPTION OF THE DRAWINGS

FIG. 1 is a partial perspective view of a prior art thumbscrew fastener;

FIG. 2 is a partial perspective view of a post of the present disclosure;

FIG. 3 is a partial perspective view of a post of the present disclosure;

FIG. 4 is a partial perspective view of a lever of the present disclosure;

FIG. 5 is a partial perspective view of a lever of the present disclosure engaging the post of the present disclosure;

FIG. 6 is a partial perspective view of a post of the present disclosure on an aquarium device;

FIG. 7 is a partial perspective view of an aquarium device, a lever, and a post of the present disclosure with the lever in the open position.

FIG. 8 is a partial perspective view of an aquarium device, a lever, and a post of the present disclosure with the lever in the closed or locked position.

FIG. 9 is a top perspective view of a post and lever of the present disclosure in the closed or locked position.

FIG. 9a is a side perspective view of a post and lever of the present disclosure in the closed or locked position.

FIG. 10 is a partial perspective view of a lever and a post of the present disclosure with the lever in the closed or locked position.

FIG. 11 is a cutout view of a lever and a post of the present disclosure with the lever in the closed or locked position.

FIG. 12 is a partial perspective view of a lever of the present disclosure;

FIG. 13 is a partial perspective view of a post of the present disclosure;

FIG. 13a is a top perspective view of a lever of the present disclosure that accompanies the post of FIG. 13;

FIG. 13b is a partial top perspective view of the post of FIG. 13 with the lever of FIG. 13a, in an open position.

FIG. 13c is a partial top perspective view of the post of FIG. 13 with the lever of FIG. 13a, in a closed position.

FIG. 14 is a partial perspective view of a post of the present disclosure;

FIG. 15 is a partial perspective view of a lever and post of the present disclosure;

FIG. 16 is a partial perspective view of a bulkhead with the fastening system of the present disclosure;

FIG. 17 is a partial perspective view of a mechanical system with the fastening system of the present disclosure;

FIG. 18 is a partial perspective view of a car jack with the fastening system of the present disclosure;

FIG. 19 is a partial perspective view of a construction mold with the fastening system of the present disclosure;

FIG. 20 is a partial perspective view of a CNC system with the fastening system of the present disclosure;

FIG. 21 is a partial perspective view of a pump fastened with the fastening system of the present disclosure;

FIG. 22 is a partial perspective view of a tree stand with the fastening system of the present disclosure;

FIG. 23 is a partial perspective view of a bushing and a fastening system of the present disclosure;

FIG. 23a is a cutout view of a bushing and post of FIG. 23;

FIG. 23b is a top view of the bushing of FIG. 23;

FIG. 24 is a partial perspective view of a squeegee brush with the fastening system of the present disclosure.

### DETAILED DESCRIPTION OF THE PREFERRED EMBODIMENTS

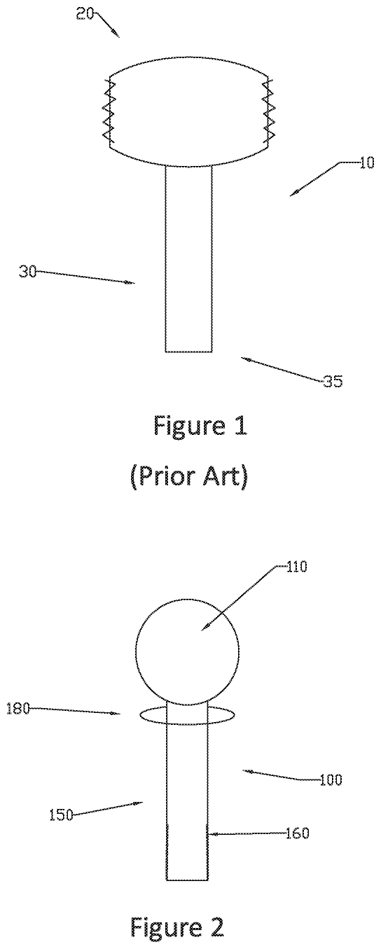

FIG. 1 demonstrates one type of prior art fastener, a nylon thumbscrew of the type often used in the aquarium industry to connect removable portions of an aquarium device, such as a skimmer, RODI canister, calcium reactor, or the like. The thumbscrew 10 includes a head 20. The head 20 may be knurled or otherwise adapted to provide a grip for the user to turn via finger pressure. The shaft 30 is attached to head 20, and is threaded 35 for screwing into a receiving portion of the device. In use, the top of a canister (not shown), for example, will include a removable lid (basically a disk) that has holes in it. The thumbscrew is threaded or placed through those holes, and into the body of the canister, where it is screwed into a threaded hole. Once screwed into place, the thumbscrew (typically several thumbscrews) holds the canister lid onto the canister, making the device water tight. When the thumbscrews are removed, the canister lid can be removed and the canister can be cleaned.

While the thumbscrew can provide a reliable attachment, it can also prove tedious to use, requiring the user to screw the thumbscrew all of the way in and out each time the equipment is to be used. As many types of equipment require a dozen or more attachment points to even out the pressure across a broad surface, their use can become a chore that causes the aquarist to skip maintenance, or face the sore thumbs from screwing each of the screws in and out.

In other industries, such as mechanical equipment, e.g., HVAC systems, inspection covers, hatches, etc., an access panel may be frequently removed. At present, instead of the thumbscrew of FIG. 1, a sheet metal screw or similar screw may be used to secure the access panel. Frequent removal of the screw becomes tedious, damages the cover, and of course requires tools.

The screws, bolts, or thumbscrews can also be a failure point, as over tightening by the user is common, wear and tear on the attachment points (e.g., an access point screwed into drywall will wear away at the drywall, for example) as is the presence of fouling or rust making it hard to remove the device without snapping the screw.

Thus, there is a need for a reliable, easy to remove and easy to lock in place fastening system. In some settings time is of the essence, and a quick removal system is important. Moreover, a fastening system that eliminates user error or overtightening, as is often present with screws and bolts, and reliably applies the same pressure and closure every time, is needed.

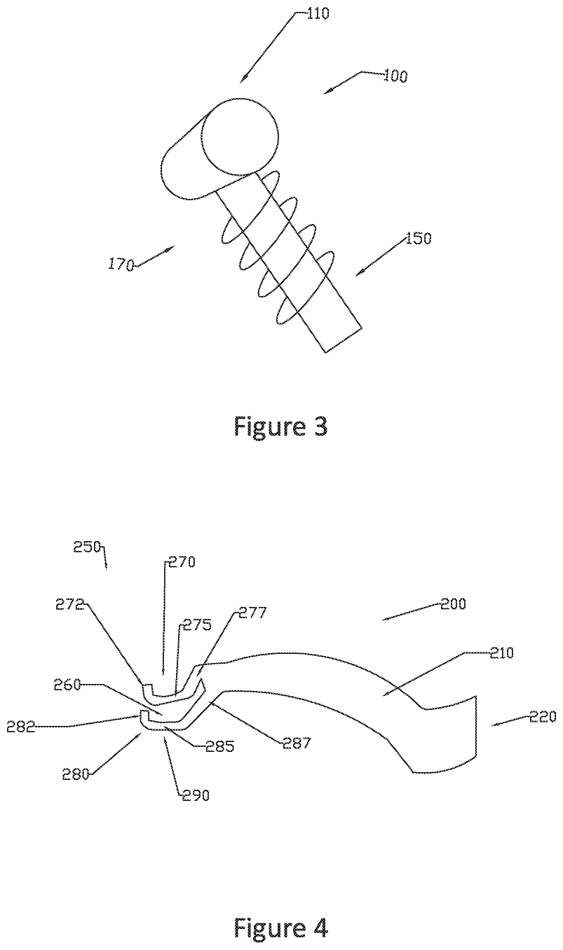

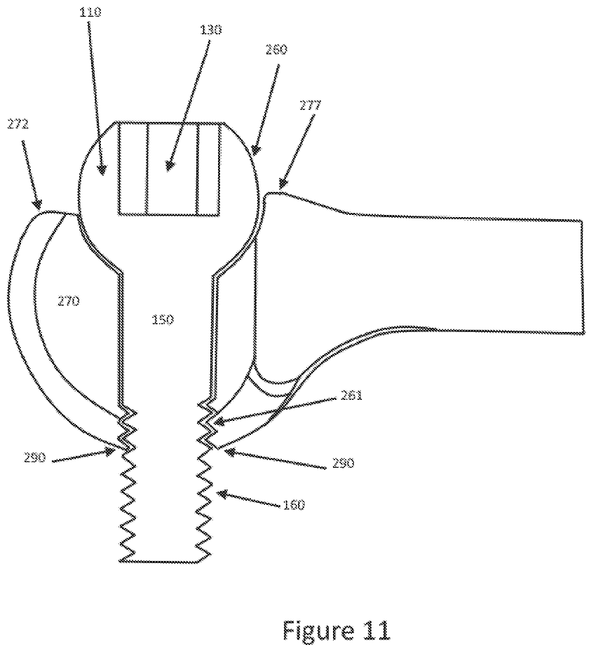

Thus, in one embodiment, the fastening system has two main portions. First, as illustrated in FIG. 2 the adjustable fastener includes a post 100. The post 100 includes a head 110 and a shaft 150. In the embodiment shown in FIG. 2, the shaft 150 includes threads 160. Head 110 may include a turning mechanism. For example, head 110 may be knurled, for finger turning, or may include a socket or a receptacle 130, a Philips head receptacle, flat head, or Allen wrench receptacle (see FIG. 11), preferably on the top. In use, for example, an Allen wrench is used to set the depth of the post. In an alternative embodiment, shown in FIG. 3, the post 100 may include a smooth shaft 150. As discussed herein the shaft may be preattached, or formed as a part of, one or more portions of the aquarium device. In this case, its depth may be preset, and thus not adjustable by the user. In the alternative, or in addition to the lever and letoff discussed herein, the shaft may include a tensioning device, such as a leaf spring, a coil 170 (FIG. 3), a spring, a spring washer, a compressible washer or compression layer. The tensioning device is preferably attached to the post 100, such that even if post 100 is removed from the aquarium device entirely, the tensioning device will remain with the post 100. In an alternative embodiment, the tensioning device is attached to a portion of the aquarium device rather than to the post 100, or is removable entirely.

The post may be formed from metal, may be 3D printed, or otherwise formed. Likewise, lever 200 (FIG. 4) may be similarly formed.

In one embodiment, as shown in FIG. 2, the post includes a washer 180. The washer 180 acts to spread out the force on the aquarium device or the bulkhead, to reduce cracking or damage to the larger unit by excessive tension. In one embodiment the washer is an integral part of the shaft 150. In another, it is a separate device. The washer can be the same or a different material. Preferably, the washer is prevented from separating from the shaft 150, e.g. via a washer clip. In another embodiment the washer is built into the body of the larger device. In another embodiment the post is permanently affixed to the larger device, and as such the washer is permanently held on the shaft.

The head 110 is preferably rounded. As shown in FIG. 2, head 110 in one embodiment is spherical. As shown in FIG. 3, head 110 may also be cylindrical. In other embodiments, the head 110 may be triangular, egg shaped, or otherwise shaped. In each case, the shape of the head is designed to match that of the lever, discussed herein, so that the two portions match and provide a letoff that releases two parts of the system, e.g. the two portions of the bulkhead or the aquarium device.

The second portion comprises the lever, as shown in FIG. 4. It is important to note that the lever, when working with the post, holds the portions of the larger device in place. Once loosened, however (as described below) the lever may be removed and will thus be out of the way so that a portion of the larger device can be removed, such as an access panel being removed from an HVAC system, or a first aid kit removed from its storage location. When the device is to be reassembled, the lever is placed back on the post, moved into the locked position, and successfully and repeatedly applies the same amount of force without the need for user input, tools, or changes.

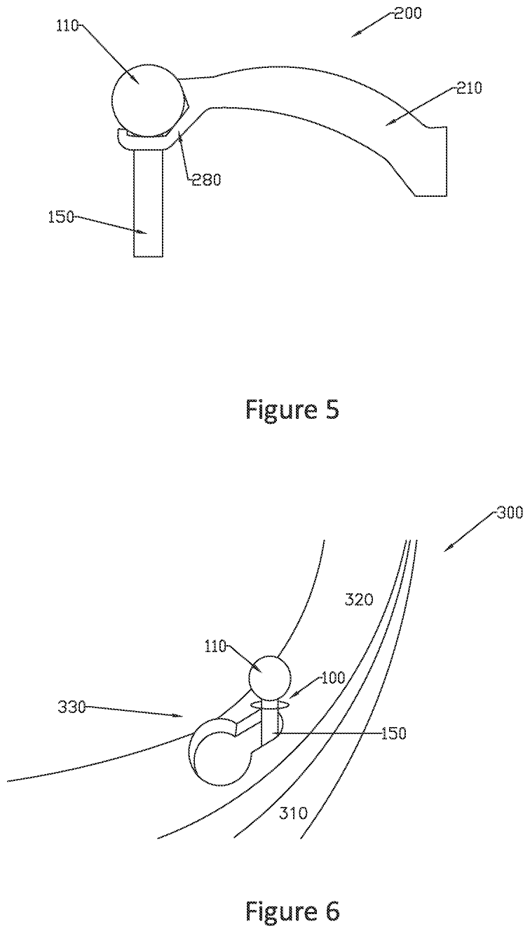

The lever 200 comprises an operating end 210 and a post end 250. The operating end may be curved 220 upward at its distal or outer end to allow for easy handling when in the closed position, where the bottom part of operating end 210 may be in contact with the aquarium device. The curved portion 220 allows the user to reach underneath the lever 200 to raise it. The post end 250 includes a gap 260 adapted to receive the head 110 of the post 100. For example, as shown in FIG. 4, the post end 250 may include a first protrusion 270, and a second protrusion 280. The first and second protrusion include gap 260 between them, and are at least as wide as shaft 150, such that shaft 150 may fit between them, as shown in FIG. 5. Gap 260 may be sufficiently sized that a portion of head 110 may fit inside gap 260 as well. First and second protrusions 270, 280 each include a depression 275, 285 in a middle portion, and include raised portions 272, 282 on the outer most end of the protrusions 270, 280. Protrusions 270, 280 further include a raised portion 277, 287 toward the inner end of the protrusions.

In one type of fastener, lever 200 is designed so that as it's moved from its open position (e.g., up, as in one embodiment) to its closed position (e.g., down) it lifts the post 100 farther up, or places an increasing tension on the post. That is, the lever works with the post to put a tensioning strain on the larger device, e.g., the access point, the bulkhead or aquarium device (or other system, as described herein). This compares with existing locking mechanisms which typically place a torqueing strain on the portions being held together (e.g., a bolt). As a result, due to the advantages of a tensioning strain over a torqueing strain, the system of the present invention may often be stronger than prior art fasteners. It is contemplated that the invention may be intentionally weakened so that it may serve as the preferred failure point for some systems or larger devices. That is, the larger device fails at a cheap readily replaceable lever (that is in fact meant to be removed from the device during opening anyway) rather than at a portion of the device that cannot be replaced. Such a weakening can be accomplished by varying the size of the protrusions, the materials used therein, by rendering them flexible under sufficient force (such that they will spread out and ride over the ball 110).

To lock the lever in the closed position, there is a “letoff.” In a preferred embodiment the “letoff” is a reduction in tension at or near the end of the rotation. This tension reduction holds the lever in that locked positions. As shown in FIG. 4, a cross section of the lever, the lever includes a tension letoff portion 290. In this embodiment the tension letoff portion is a flat portion. When the lever reaches the flat portion the tension undergoes a slight reduction, such that opening the lever first requires a small force to lift the lever past that letoff (and thus briefly increasing the tension) before the lever is fully opened. In the absence of a force applied by the user, the lever will stay with the flat portion in contact with the device.

In the embodiment depicted in FIG. 4, lever 200 is not permanently affixed to post 100, and may be removed therefrom. In particular, in use when the lever is moved up, removing the tensioning force, the lever can be removed. Thus, the portion of the bulkhead or aquarium device that is meant to be removed can simply slide over the fastener shaft 150 and be removed.

In operation, post 100 is threaded into or otherwise attached to a first portion 310 of a device 300, a portion of which is shown in FIG. 6. For example the larger device 300 could be an aquarium device, a bulkhead, an access point for an HVAC or mechanical system, etc. The first portion 310 will include a hole or attachment point (not shown). Shaft 150 of post 100 is threaded into the first portion 310 to the desired depth. In a preferred embodiment, the depth can be adjusted as needed, as discussed above. A second portion 320 of the larger device 300, will be placed over and secured to the first portion 310 using the adjustable attachment device. The second portion 320 may include a keyhole 330 such that the second portion can be placed over the first portion while the post 100 is at least partially in place. The second portion is then rotated so that the shaft 150 is in the smaller diameter section of the keyhole. In other embodiments, the second portion has a hole barely wider than post 100, and is placed on the first portion 310 before the post 100 is threaded into position. In other embodiments, the hole is barely wider than the head 110, and is held in place by the lever 200 being wider than the hole.

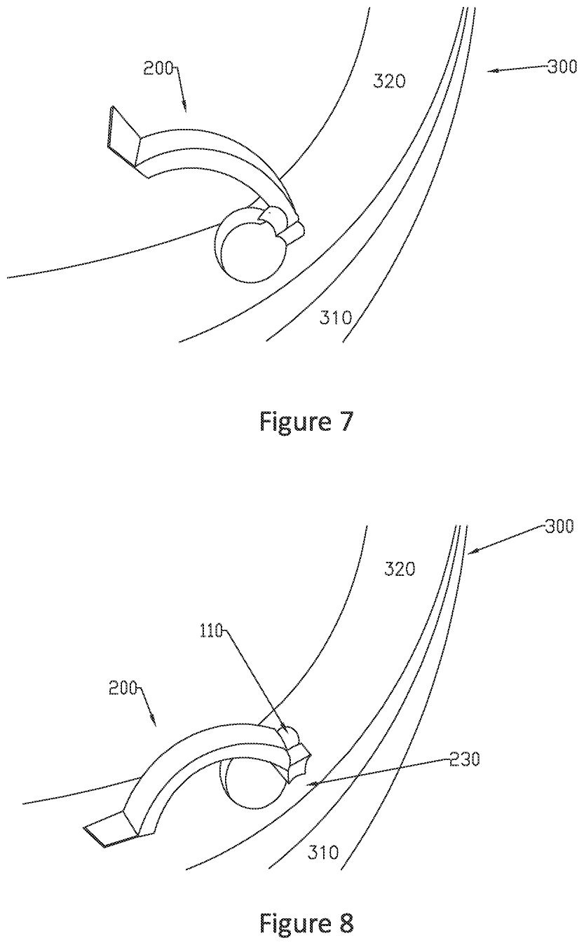

Once the post 100 is threaded to the desired depth, the lever 200 is placed around the post 100, such that protrusions 260, 270 are between the second portion 320 and the head 110. See FIG. 7. In this step, the lever 200 is typically oriented upward. In a second embodiment—not shown—the lever 200 is initially placed around post 100, but is flat, or parallel to the second portion 320. In either case, the lever is not yet putting the post under significant tension to lock the first and second portions of the device together. As shown in FIG. 8, the lever may then be lowered (or raised, depending on the embodiment) to place the post under tension, locking the first and second portions 310, 320 together.

To separate the first and second portions for maintenance or cleaning the lever 200 is then raised back to the position shown in FIG. 7. In some embodiments the lever can then be removed, and the second portion 320 of the aquarium device may be removed from the first portion 310. Allowing for the removal of the lever makes it substantially quicker and easier to remove the device than if the lever is integrated with or affixed to the post. In these embodiments there may be one lever for each post 100, or there may be a single lever for all of the posts 100, where the lever locks the post in place and then may be removed and used on the next post.

In other embodiments, the lever is shaped or sized such that it may pass through the key hole in the second portion as the second portion is removed. Thus the second portion can be removed, and then placed back into position. However, in this situation the keyhole must be substantially larger, and the lever may need to be smaller as well, to allow it to pass through the hole. Thus, it may be harder to work with, less strong, and less reliable.

The lever puts the post under tension by its shape. As shown in FIG. 5 the lever 200 includes a curved bottom edge of its distal most portion. This curve allows raised portions 272, 282 to fit under the head 110 of the post. As the main body 210 of the lever is lowered more of the lever fits under the head 110, and the head 110 moves into the depression 275, 285. The head 110 is then held into the depressions 275, 285 as it fits between the more distal raised portions 272, 282 and the more proximal raised portion 277, 287. The lever locks into position due to, in one embodiment, the presence of a letoff portion, in this case flat portion 290 on the bottom edge under the depressions 275, 285.

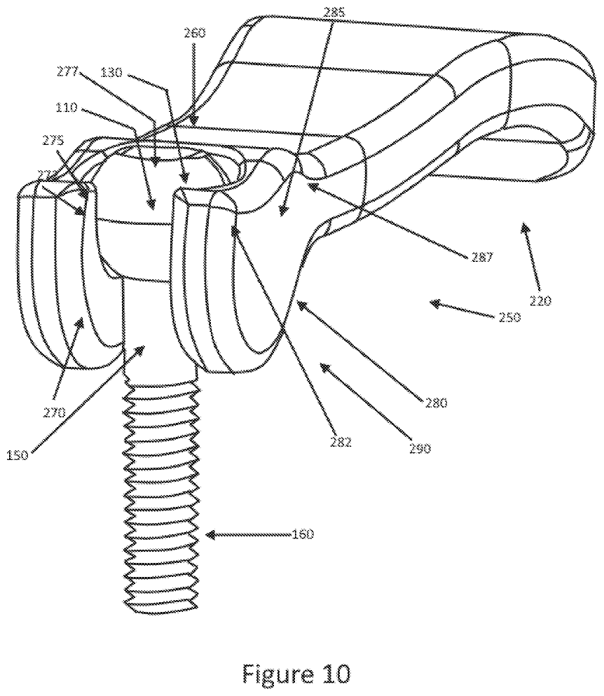

In practice, the highest amount of tension on the post 100 is just before the lever is flat (or fully raised in the second embodiment, above). So, for example a cam style lever 200 (See FIG. 10) in which the center point of the rotation is off center may increase pressure by rotating to a thicker and thicker portion of the lever (or in other embodiments, of the head 110). At the end, the rotation brings the head to a slightly thinner portion of the cam, reducing the tension. The thinner portion may be a slightly thinner portion of the cam, or may be a flat portion 290 (FIG. 4). Once the lever is fully flat—and thus the flat portion 290 is in contact with the aquarium device, typically at layer 320,—the tension lets off slightly, locking the shaft into position. While lever 200 is depicted as having a flat portion, other shapes are contemplated. In particular, the distal portion of the lever may have an egg shaped end, and thus again the tension on the post is raised until just before the locking position. As it finishes into the locking position the tension is reduced, and holds lever in place. The lever stays in the locked position as it would require an increase in tension on the post to move it back up, and this will only happen when the user acts on the lever.

The amount of letoff will depend on the needs of the device. For example, how tightly the device must be sealed. A device under significant pressure may need to be sealed very tightly. A device for which leaks or air gaps are not significant may be very loosely sealed. In one embodiment the letoff ranges from 0.1 mm to 0. In another embodiment the letoff range includes 0.2 mm to 0.001 mm. In a preferred embodiment the letoff ranges from 0.001 mm to 0.01 mm. The presence of tensioning members may also impact the letoff. So for example, if the post includes a spring (See FIG. 3) the letoff can be more significant as the spring may maintain the pressure holding layers 320, 310 together through a larger letoff.

Many devices will include a gasket between the layers (not pictured). The gasket may be a band that fits into a groove between the layers, or a flat, flexible layer between layers 320, 310. If so, the letoff amount will depend on how much the gasket compresses. A very soft gasket will compress more, and allows for a larger letoff. In a preferred embodiment the aquarium device includes a 1 mm gasket, and thus the letoff is smaller, such as 0.01 mm, or preferably 0.001 mm.

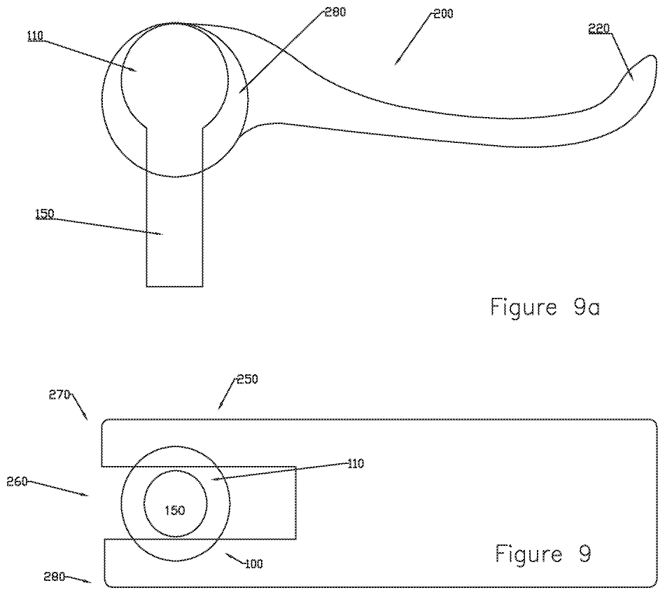

In a second embodiment, shown in FIG. 9, the lever may include protrusions 270, 280, with a post end 250. The post end 250 includes a gap 260 adapted to receive the head 110 of the post 100. For example, as shown above in FIG. 4, the post end 250 may include a first protrusion 270, and a second protrusion 280. The first and second protrusions include gap 260 between them that is at least as wide as shaft 150, such that shaft 150 may fit between them, as shown in FIG. 5 and FIG. 9.

As shown in FIG. 10, gap 260 may be sufficiently sized that a portion of head 110 may fit inside gap 260 as well. First and second protrusions 270, 280 may include a depression 275, 285 in a middle portion. However, in another embodiment, the gap 260 is shaped and sized to hold head 110, and or a portion of shaft 150, and the depressions 275, 285 are not required. The protrusions 270, 280 may include raised portions 272, 282 on the outer most end of the protrusions 270, 280. Protrusions 270, 280 may further include a raised portion 277, 287 toward the inner end of the protrusions.

In the embodiment of FIG. 9a, the lever further includes shroud 295, which wraps around head 110. Shroud 295 may fully encapsulate head 110, holding lever 200 and post 100 together so that they are not accidentally separated. Shroud 295 may partially encapsulate 110.

As shown in FIG. 11, lever 200 may include threading 261 in gap 260. Threading 261 may match the threading 160 on shaft 150, such that in operation threading 160 may go both into aquarium device portion 310 and into lever 200, holding the system together. Likewise, the threading 261 may hold the lever 200 and bolt 100 together, such that they can be separated, but unless specifically removed by the user, the lever stays with the bolt. Head 110 may include a socket or a receptacle 130, a Philips head receptacle, flat head, or Allen wrench receptacle, preferably on the top, for ease of tightening/loosening.

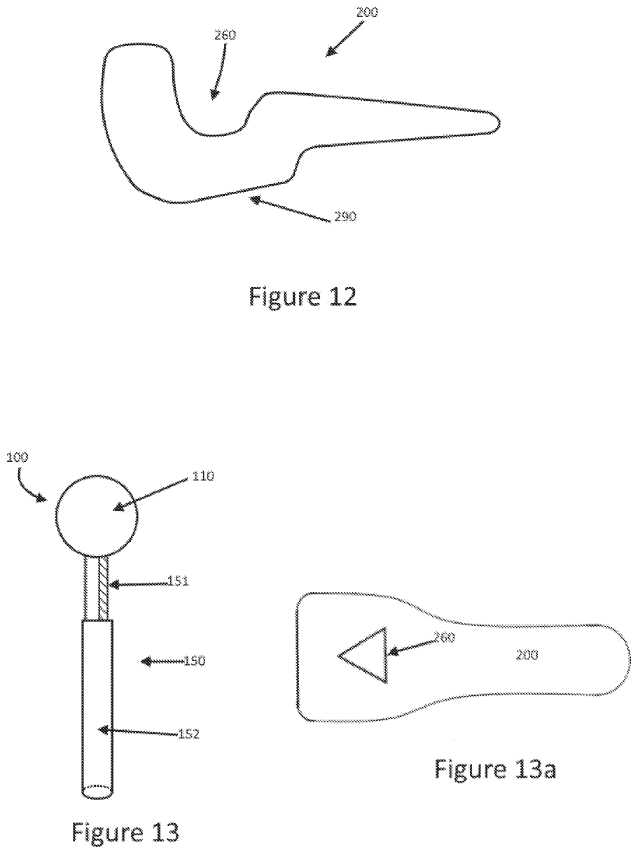

In one type of fastener, lever 200 is designed so that as it's moved from its open position (e.g., up, as in one embodiment) to its closed position (e.g., down) it lifts the post 100 farther up, or places an increasing tension on the post. However, to lock the lever in the closed position, there is a “letoff.” In a preferred embodiment the “letoff” is a reduction in tension at or near the end of the rotation. This tension reduction holds the lever in that locked positions. As shown in FIG. 4, a cross section of the lever, the lever includes a tension letoff portion 290. In this embodiment the tension letoff portion is a flat portion. When the lever reaches the flat portion the tension undergoes a slight reduction, such that opening the lever first requires a small force to lift the lever past that letoff (and thus briefly increasing the tension) before the lever is fully opened. In the absence of a force applied by the user, the lever will stay with the flat portion in contact with the aquarium device. In the embodiment of FIG. 10, the tension letoff 290 portion is the bottom of the egg shaped portion. As shown in FIG. 12, the tension letoff portion 290 may be similar to the flat version of FIG. 4, but instead of flat it may be sloped.

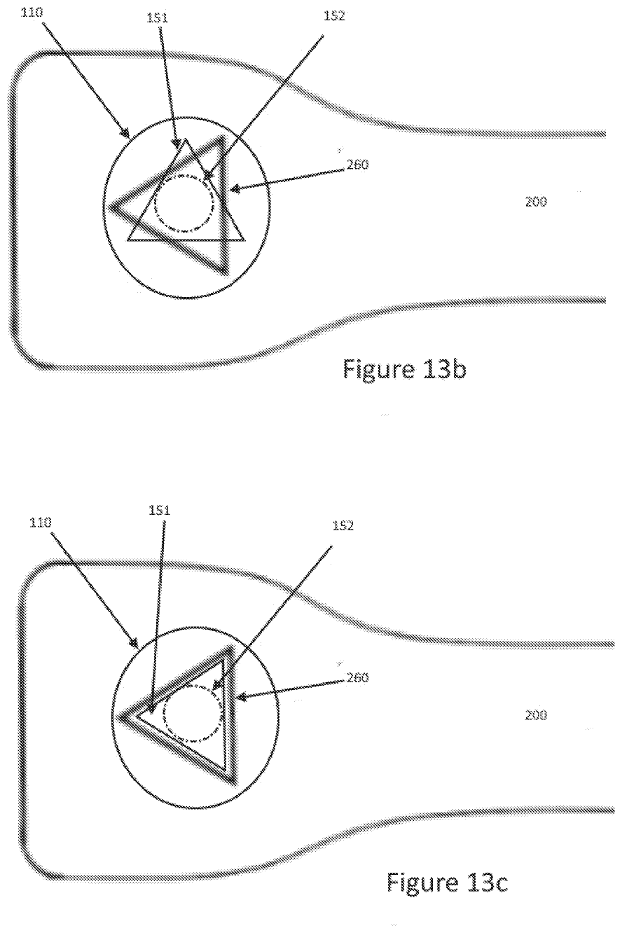

As shown in FIGS. 1-8, the lever protrusions 270 280 are straight and parallel. In another embodiment, the lever protrusions are curved to reach around the shaft 150. In still another embodiment the lever protrusions are straight, but not parallel, such that the gap forms a triangle. In such a case, the gap would ideally match the shape of the shaft at the location the two come in contact. For example, for a triangular gap the shaft could be triangular. The shaft could also be square, but be turned so that one corner of the shaft is oriented into the vertice of the triangular gap. In preferred embodiment the shaft is round for a majority of its length, and only forms a different shape in the region it intersects with the lever. As shown in FIG. 13, the shaft 150 may have a shaped portion 151 (triangular as shown, or square, hexagonal, etc.) at its top end near head 110, and a cylindrical portion 152 (or another cross sectional shape) in the portion that enters the aquarium device. As shown in FIG. 13a, the gap 260 would then match the shape of shaped portion 151. In use, as shown in FIG. 13b, the fastener 100 is placed through the gap 260 in the lever 200, and into the aquarium device. For example, it could be threaded to the desired depth. At this point, the lever 200 is rotated, as shown in FIG. 13c, so that gap 260 mates with shaped portion 151, allowing a tension “letoff.” In this embodiment the triangular shaft portion 151 is preferably shorter than that pictured in FIG. 13, so that the letoff is shorter.

Thus, in this embodiment the bottom of the lever does not need to provide the lefoff because the mating of the gap 260 with the shaped portion 151 provides a letoff when it reaches the locking position.

In this case the tension letoff may alternatively allow for easy removal of a portion of the aquarium device, or it may allow for locking the shaft in position. In the embodiment that allows for easy removal at the point where 151 and 260 match, the lever is rotated until they match. At this point the triangular shaft portion 151 shown in FIG. 13, matches exactly with the triangular gap 260 in FIG. 13a, and due to that match the post can slide down into the gap, releasing the tension. The triangular shaft portion may be longer (see FIG. 13) in order to allow a longer release distance. In this case it is preferred that at least one side or face of the triangular shaft portion extend beyond the outer surface of the cylindrical shaft section 152.

In many of these embodiments, the lever may include a ramp on the top or bottom that allows the rotation to slowly increase the tension as the lever is rotated. E.g., the shaft portion 151 is not all in or all out of the matching gap, but slowly moves into it as the rotation occurs. This allows for easier rotation as well. Correspondingly, such a ramp could be present on the shaft as well.

The letoff may then be present in the ramp(s). In one embodiment, the gap 260 has multiple layers. Rotating the lever in one direction may force the shaped portion up a sloped surface to increase the tension, until it fits exactly into a depression in gap 260, locking the shaft into place.

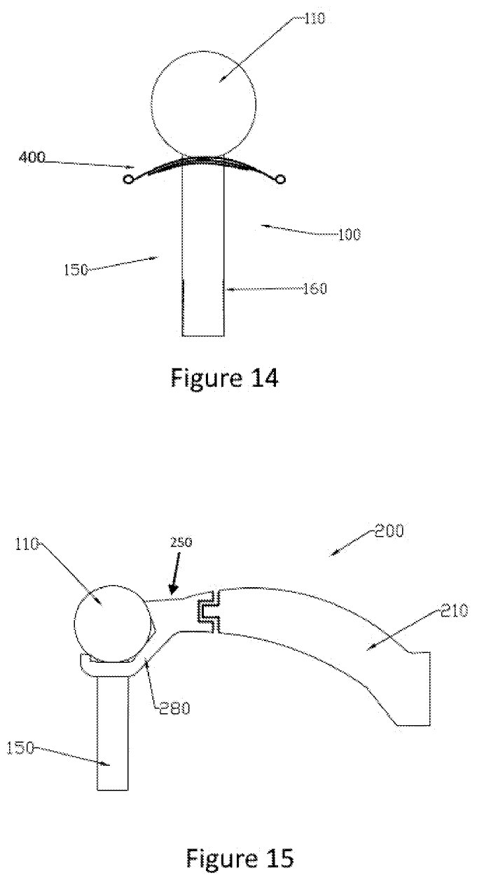

In one embodiment, the adjustable locking fastener further comprises a tensioning element. For example, as shown in FIG. 14, the fastener may include a spring 400. One advantage of a spring is to provide a constant level of tension. When using various plastic or polymer materials over tensioning can easily strip screw threads, crack materials, etc. The use of a spring to provide a constant tension allows the user to have flexibility in how far into the device the post 100 is inserted, without overly increasing the tension. In addition, a spring 400 allows the locking mechanism to work past its highest tension level into its locking position without cracking the materials. In other embodiments the tensioning member may be a leaf spring, a coil 170 (FIG. 3), a spring washer, a compressible washer or compression layer 400. Multiple tensioning members may also be provided, for example a spring on post 100, and a compression layer or seal between the two portions of the aquarium device.

The adjustable locking fastener may further include a locking mechanism to prevent accidental dislodgement. For example, a spring loaded pin (not shown) may fit from the lever through a detent in the head. The pin must be depressed and released before the lever may be raised, opening the device.

In another embodiment, shown in FIG. 15, the lever comprises a first portion and a second portion, the first and second portions being separable. In this embodiment, the first portion comprises the operating end 210, and once the post end 250 has locked onto the shaft and is in position to hold the device, the operating end is removed, leaving the second portion (post end 250) in place to lock the device together. The portions may be joined via a friction fit of closely mated portions, screwed together, latched together, or otherwise.

In another embodiment the post 100 may have an egg shaped head 110 on top of post 150. The lever 200 then has an egg shaped gap 260 matching head 110. In the embodiments discussed for FIGS. 1-12, the letoff is typically found at the meeting of the bottom of the lever and the top of the larger device. As in FIG. 13, however, the letoff may be between the post and the lever.

Numerous embodiments are possible for the posts and levers, as set out in detail in U.S. patent application Ser. No. 17/583,424, filed Jan. 25, 2022, and those embodiments are incorporated by reference herein.

In some embodiments the “lefoff” may simply be a position that maintains the exact tension, without increasing it. That is, if the tension would be maintained at a similar level as the lever was moved up and down over a range of motion, the lever will tend to stay locked in place until it is rotated far enough to beginning removing the tension, but absent a force the lever will stay in place as there is no advantage to it moving. Thus, a letoff portion in this embodiment may have the same radius over a portion of its rotation. That is, as the lever is moved down, for a time the tension increases (the distance between the fulcrum and the outer edge of the lever that is at that moment in contact with the aquarium device is increasing, adding tension) until it reaches a portion that is rounded, and in which the distance between the fulcrum 350 and the outer edge remains constant, thus providing a constant amount of tension.

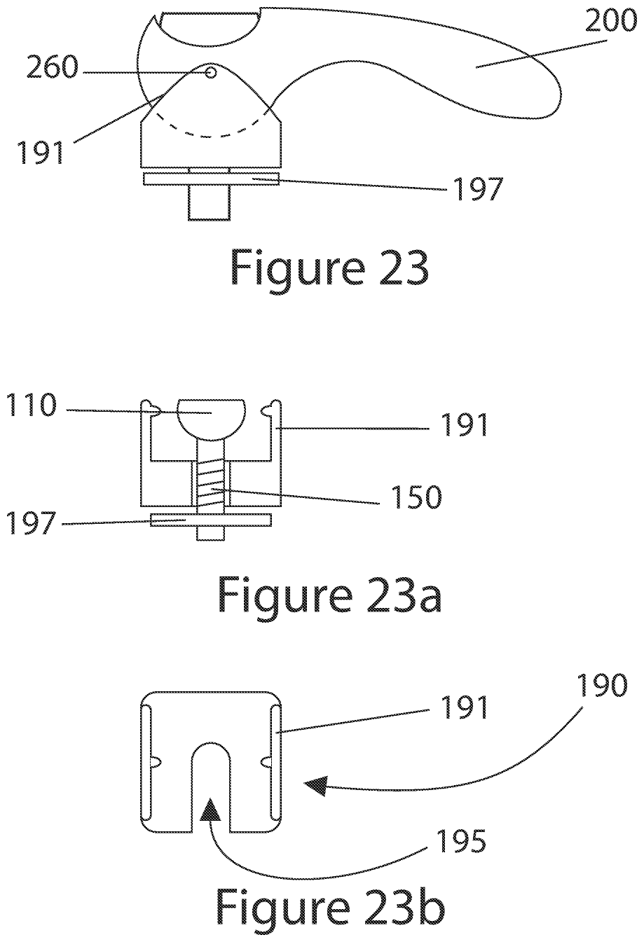

In some settings it may be desirable to distribute the tensioning force across a large surface portion of the underlying device. As shown in FIGS. 23, 23a, and 23b, the lever 200, instead of providing tension directly to threaded post 150 (or non threaded post 100, pictured earlier), head 110, or the larger device 300, may attach to a bushing 190. The bushing 190 may then spread the force over a larger surface area. Typically the lever 200 would comprise a smaller hole 260, into which arms 191 of bushing 190 fit, in one embodiment one arm on each side. The bushing may have a concave surface to mate with the bottom of the lever 200. In some embodiments this bushing will distribute the force more evenly. In others it will provide a reduction in friction with the lever. The head 110 and threaded post 150 (or non threaded post 100, pictured earlier), may fit into or through the busing via slot or hole 195, and may be connected with the bushing, or may still be held by the lever (rather than the lever connecting to the bushing). The system may also comprise a nut or washer 197 between the bushing 190 and the larger device 300. Washer 197 can be round or another shape, have varying thickness, be similar or dissimilar in material to the bolt, and can be permanent or adjustable in position. Typically, it will have a larger cross section than the head of the bolt but in some embodiments it may be smaller. The washer 197 prevents the bolt from screwing further down than desired and provides a means of positioning a single or multiple layers of substrate being fastened. The substrate can have a similar or dissimilar size/shape/thickness then the receiving hole.

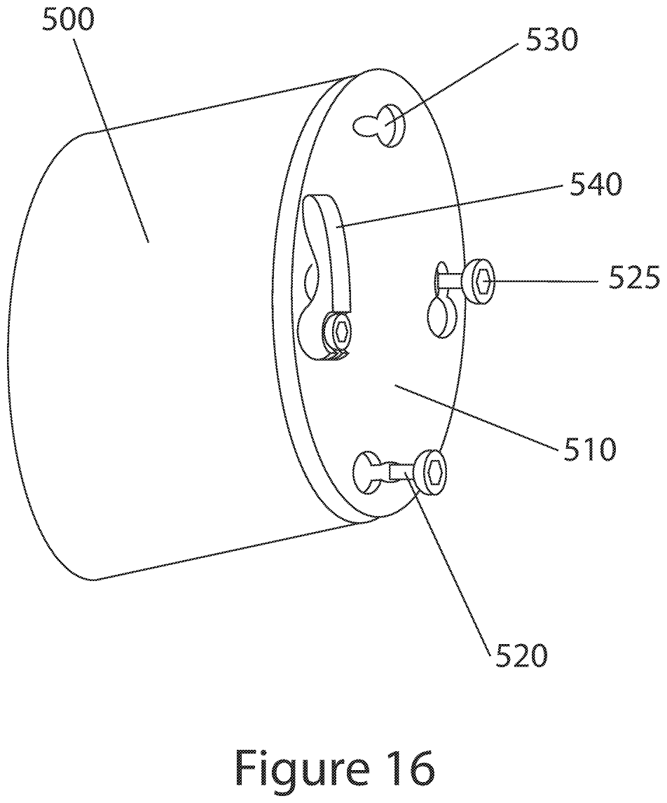

The fastening system described above may be useful in numerous settings. As shown in FIG. 16, a bulkhead may consist of a body 500, and a cover 510. The body may have numerous posts 520 that when the larger device, the bulkhead, is fully assembled match up with and fit through holes 530 in the cover 510. Holes 530 can be a circular hole just big enough to fit the posts 520 through, or could be a keyhole shape. Any other appropriate shape for the hole is acceptable. Levers 540 then are placed on the heads 525 of posts 520, rotated into a locked position, thus placing the cover 510 and the body 500 under a tensioning strain, locking them together and sealing them. In certain bulkheads the ability to remove the cover 510 quickly and easily can be critical to remove clogs, relieve pressure quickly, or simply for cleanings. In some settings cleaning systems requires the removal of numerous fasteners, and the present invention makes this process not only substantially faster and easier, but also more easily repeatable with less damage to the device.

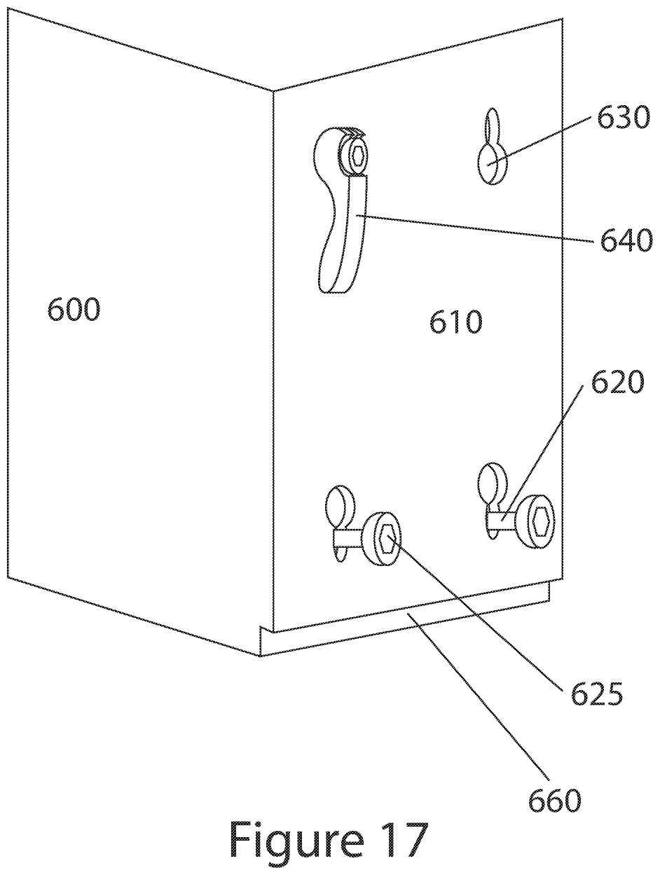

In many buildings mechanical systems are required to have access covers. As shown in FIG. 17, a mechanical system 600 may have a cover 610. The system may have two or more posts 620 as shown in FIG. 17 that when the system is fully assembled the posts 620 match up with and fit through holes 630 in the access point or cover 610. Levers 640 then are placed on the heads 625 of posts 620, rotated into a locked position, thus placing the cover 610 and the body 600 under a tensioning strain, locking them together and sealing them. In the embodiment shown in FIG. 17, the access point 610 may have a lip 660 at the bottom for attachment to the system 600—that is the lip slides over the edge of the opening, and rests on it holding the bottom of the cover 610 in place so long as the top is held by the fastening system. In other embodiments two fastening systems may be used along with the lip, or another number, e.g., four, six, or eight as needed.

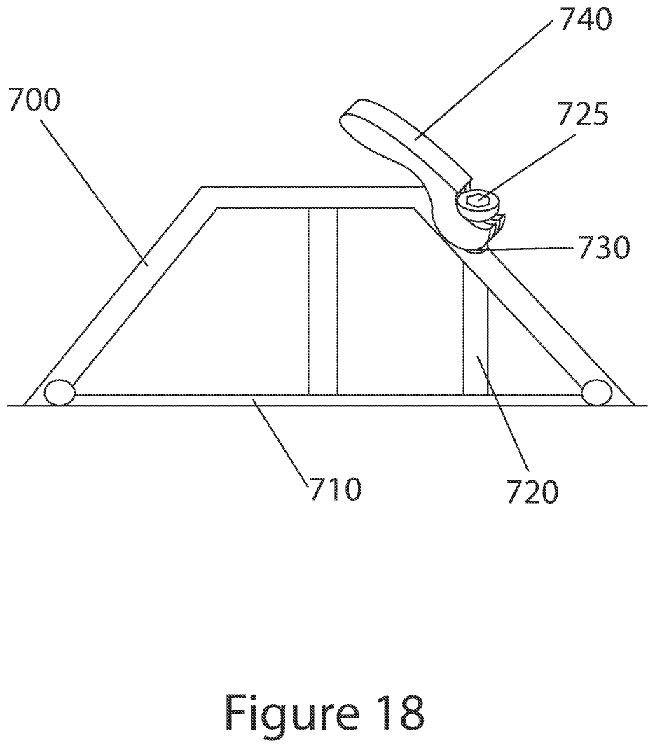

Many vehicles carry some form of emergency gear, such as a car jack, repair tools, first aid kits, and the like. Currently many spare tires and car jacks are stored in place via a threaded post and a wing nut or similar attachment. Of course, these tools are most needed when the driver is stranded on the side of the road, often in bad weather and with traffic close by. A faster removal system is needed, and the present invention provides one. As shown in FIG. 18, the car jack 700 is typically in trunk 710 or otherwise on the vehicle, and has one or more holes 730. The car jack 700 may then have one or more posts 720 that fit through hole(s) 730. Head 725 is then mated with securing fastener 740, which secures the car jack in place until needed. Similar systems can secure a spare tire or a first aid kit, a trailer hitch, tools, storage, or other equipment on a vehicle Likewise, these items could be secured in a building in like fashion, allowing quick access to needed equipment.

There are many other vehicle uses for the present system. For example, the fastening system could be used with a roof rack system to attach items to the roof rack. The fastening system could be used for a carburetor cover, to lock in expanding wheels on a garden cart, to attach tools to an ATV, to attach a plow quickly and easily.

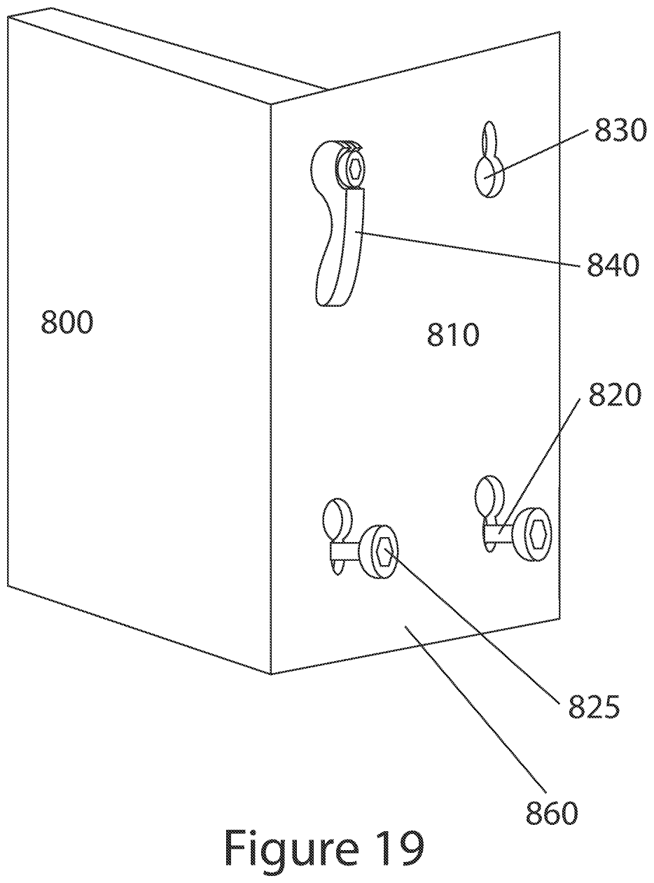

As shown in FIG. 19, the fastening systems disclosed herein are also useful for construction forms and molds. A first mold part 800 may have posts 820 that fit through holes 830 in a second mold part 810. Posts 820 have a head 825. Levers 840 fit on head 825 and then lock the first and second mold parts 800, 810 together to form the mold. When the mold's work is done, it is easily removed. Importantly, this happens with no damage to the mold, and it can be reused over and over, unlike many prior art fasteners, which will over time damage the portion they are screwed or bolted into. It is also substantially faster than molds the at use a press or straps to bind the portions together. The present invention would be useful for many mold types, such as a concrete mold, other construction molds, glass molds, fiberglass molds, and many more.

For those molds where a material is injected and cured, it would then be quick and easy to remove the mold with the present fastening system from the injector and leave in place until cured, and then remove the mold by releasing the fasteners.

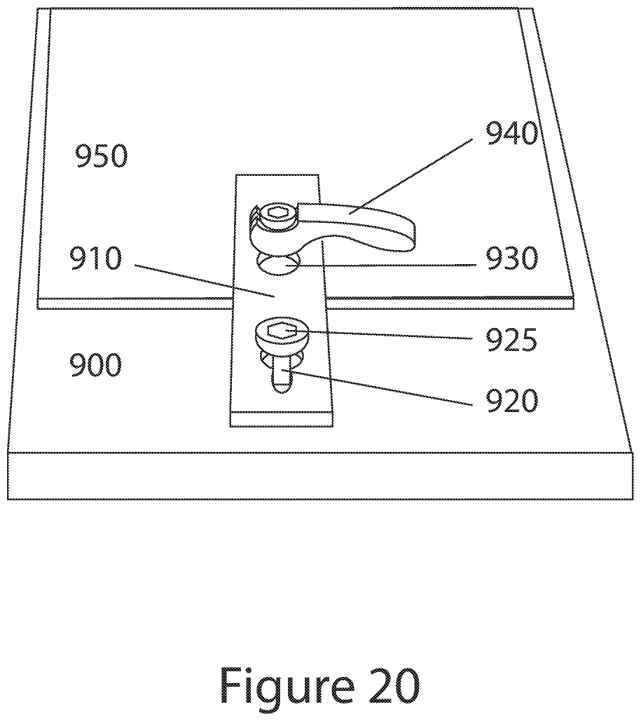

In CNC machining, the working piece must be placed in position, securely locked down, and then later removed, often over and over. The present invention can provide CNC clamping plates and jigs that are easy to place in position and lock down, as shown in FIG. 20, and just as easy to remove, speeding up a repetitive portion of the work. Thus, the CNC table 900 may have posts 920 and holes 930 into which posts 920 can fit. Posts 920 have heads 925. A clamping plate, shim, or jig 910 is placed over the work piece 950, and lever 940 is then applied to the post 910 to lock the work piece 950 in place. The posts 920 may be fixed in place, moveable, or some combination of the two.

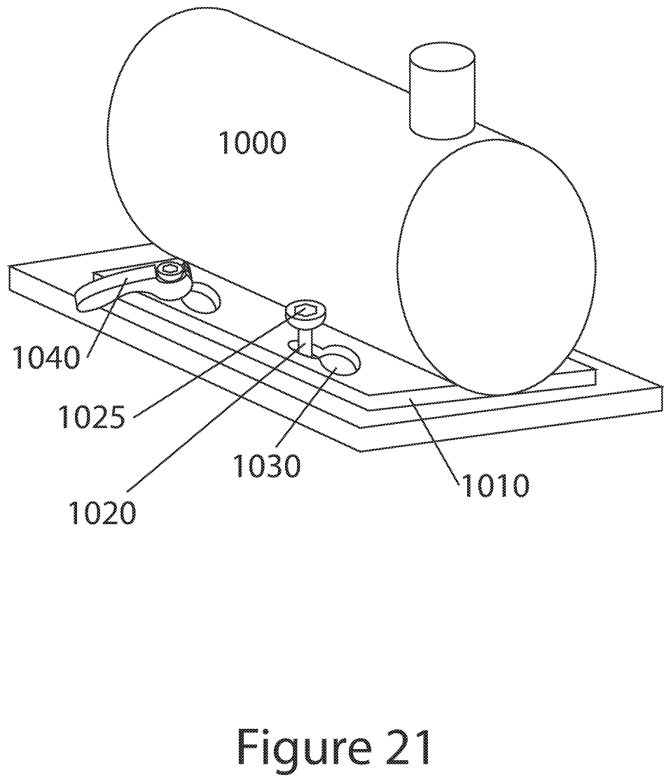

As shown in FIG. 21, the fastening system can be used to hold equipment in place until it must be removed. For example, pump 1000 has a base 1010 that includes holes 1030. Posts 1020 and/or head 1025 fit through holes 1030. Lever 1040 secures the pump 1000 in place by applying tensioning force to the posts.

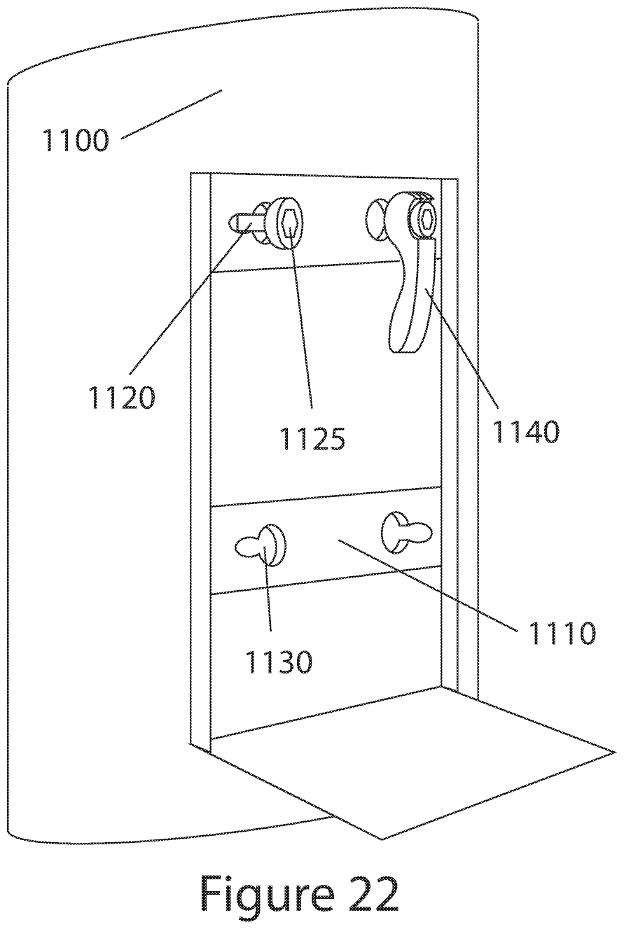

As shown in FIG. 22, the fastening system is also useful for outdoor equipment. Tree stand base 1100 is secured to a tree using straps or bolts. In use the fastening system applies tensioning force to bars 1110 via levers 1140. Bars 1110 have holes 1130 through which posts 1120 with heads 1125 fit. The posts 1120 can be in the tree, or can be in a securing device, such as a strap that wraps around the tree. Thus the tree stand can be readily removed or repositioned as needed by simply taking the levers on and off. The same system can be used for bird feeders and other outdoor items.

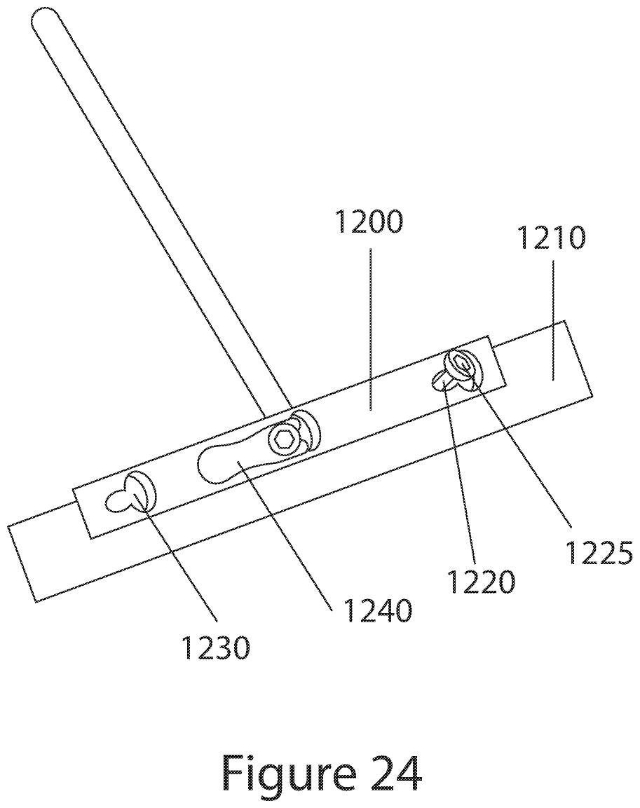

As shown in FIG. 24, the fastening systems disclosed herein are also useful for tools and equipment, such as cleaning equipment, a Zamboni squeegee, or the like. The first tool portion or body 1200 is configured to work with one or more active tool portions 1210. In some cases the tool portion is one option that may be switched out as the project progresses, such as a sander, where different grits are needed over time. In other cases the tool portion 1210 is the part that will wear out, and as such must be replaced.

As shown in FIG. 24, active tool portion 1210 is a squeegee for a Zamboni. First tool portion 1200 includes holes 1230, through which posts 1220 with heads 1225 fit. Lever 1240 locks the first tool portion 1200 and the active tool portion 1210 together. In the alternative, active tool portion 1210 may include the holes 1230, through which posts 1220 fit.

The adjustable locking fastener may be made of materials suitable for use in the particular device. For example, if for use in an aquarium the plastics would be preferably food grade, such that materials will not leach into the aquarium harming the livestock. Water resistant materials such as plastics, especially food grade plastics, PVC, ABS, stainless steel, epoxies, carbon fiber, silicon, acrylics, PET, PTFE, Nylon, injection molded plastics, aluminum (anodized or not anodized), powder coated materials, etc. are appropriate materials. The material used may be the same as that used in the aquarium device. For example, a calcium reactor made of acrylic may utilize an acrylic adjustable locking fastener. In embodiments, the adjustable locking fastener is colored to make the parts easy to see. An orange, or glow in the dark fastener will be easier to work with, line up, and use in a dark environment underneath an aquarium. Likewise, many aquariums use UV lighting for various purposes, and as such a UV reactive material, e.g. one that will fluoresce under UV lighting, may be preferred.

If for use in a bulkhead, the materials would preferably be appropriate for the environment the bulkhead must operate in, including resistance to toxic materials, temperature, and the like. If for use in an access point, the material may be preferably made of a similar metal to the sheet metal access point.

1. An adjustable locking fastener comprising:
a post, the post comprising
a shaft and a head
a lever, the lever comprising
a first and a second protrusion with a gap between them, the gap sized to accommodate the post;
a first raised portion, a second raised portion, and a depression between the first and second raised portion, the depression sized to accommodate the head; and
a letoff portion.

2. The adjustable locking fastener of claim 1 wherein the lever is configured to be removable from the post without tools.

3. The adjustable locking fastener of claim 1 wherein the lever has an open position and a closed position, wherein the lever is configured to apply a tensioning force to the post in the closed position.

4. The adjustable locking fastener of claim 1, wherein the leftoff portion is rounded.

5. The adjustable locking fastener of claim 1, wherein the letoff portion is flat

6. The adjustable locking fastener of claim 5 wherein the flat letoff portion has a different axis than the lever.

7. The adjustable locking fastener of claim 1, wherein the head includes a tightening means.

8. The adjustable locking fastener of claim 1, wherein the head includes a recess.

9. The adjustable locking fastener of claim 1, wherein the depression is sized to hold the head.

10. The adjustable locking fastener of claim 9, wherein the depression is shaped to provide a letoff when the head is fully seated inside the depression.

11. The adjustable locking fastener of claim 9 wherein the depression surrounds the head.

12. The adjustable locking fastener of claim 9, wherein the depression partially surrounds the head.

13. The adjustable locking fastener of claim 3, wherein the lever is configured to rotate from the open position to the closed position.

14. The adjustable locking fastener of claim 13, wherein the lever is configured to increase the tension on the post as it rotates from the open position to the closed position.

15. The adjustable locking fastener of claim 14, wherein the letoff portion is configured to reduce the tension on the post at the end of a lever rotation.

16. The adjustable locking fastener of claim 2, wherein the lever is configured to apply a preset amount of tensioning force to the post.
